(19) United States
(12) Patent Application Publication
(10) Pub. No.: US 2026/0066311 A1
(43) Pub. Date: Mar. 5, 2026

(54) SECONDARY BATTERY AND MANUFACTURING METHOD THEREOF

(71) Applicant: SAMSUNG SDI CO., LTD., Yongin-si (KR)

(72) Inventor: Junho BYEON, Yongin-si (KR)

(21) Appl. No.: 19/222,787

(22) Filed: May 29, 2025

(30) Foreign Application Priority Data
Sep. 3, 2024 (KR) 10-2024-0119309

(51) Int. Cl. H01M 4/76; H01M 10/04; H01M 50/342

(52) U.S. Cl. CPC H01M 4/765; H01M 10/0481; H01M 50/3425

(57) ABSTRACT

A secondary battery includes a can-type case accommodating an electrode assembly, an electrolyte inlet on a first end of the case, and configured to allow an electrolyte to be injected therethrough, a first thin film cover sealing the electrolyte inlet, and having a through-hole, and a second thin film cover sealing the electrolyte inlet and the through-hole, and located on the first thin film cover.

### CROSS REFERENCE TO RELATED APPLICATION

The present application claims priority to and the benefit of Korean Patent Application No. 10-2024-0119309, filed on Sep. 3, 2024, in the Korean Intellectual Property Office, the entire disclosure of which is incorporated herein by reference herein.

### BACKGROUND

### 1. Field

The present disclosure relates to a secondary battery and a manufacturing method thereof.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

Secondary batteries are categorized as liquid electrolyte lithium-ion batteries and polymer electrolyte lithium-polymer batteries based on the type of electrolyte used, or as cylindrical, prismatic, and pouch batteries based on the shape of the batteries manufactured.

In pouch secondary batteries, a flat film case is formed using a mold machine or a press, and then the case is filled with an electrolyte in a state in which the case is sealed. Once the electrolyte is injected, a pre-charging process of performing charging and/or discharging under heat and pressure and an aging process of leaving a charged and/or discharged secondary battery at room temperature so that the electrolyte is uniformly distributed within the secondary battery are performed. In addition, because the pre-charging and aging processes generate gases, a degassing process is further performed to remove the gases generated during the aging by forming air pockets.

In contrast, secondary batteries, in each of which a case is manufactured in a can type rather than a film type, desirably have a separate electrolyte inlet. However, can-type secondary batteries are prone to electrolyte leakage and contamination during the pre-charging and aging processes. Therefore, a process for sealing the electrolyte inlet is desired to solve this problem. On the other hand, in order to improve electrolyte impregnation of an electrode assembly, it is desirable to replenish the electrolyte. Therefore, it is desirable to provide a sealing member that is suitable for situations where further electrolyte filling is desired after the sealing of the electrolyte inlet.

The above information disclosed in this Background section is for enhancement of understanding of the background of the present disclosure, and therefore, it may contain information that does not constitute related (or prior) art.

### SUMMARY

Aspects and features of embodiments of the present disclosure is to provide a secondary battery and a manufacturing method thereof for solving the above problems.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

According to one or more embodiments of the present disclosure, a secondary battery includes a can-type case accommodating an electrode assembly, an electrolyte inlet on a first end of the case, and configured to allow an electrolyte to be injected therethrough, a first thin film cover sealing the electrolyte inlet, and having a through-hole, and a second thin film cover sealing the electrolyte inlet and the through-hole, and located on the first thin film cover.

According to one or more embodiments, the first thin film cover may be thinner than the second thin film cover.

According to one or more embodiments, the first thin film cover may be larger than the electrolyte inlet and may cover an outer portion of the electrolyte inlet, and the second thin film cover may be larger than the first thin film cover.

According to one or more embodiments, the through-hole may be formed by rupturing a vent line on an outer portion of the electrolyte inlet of the first thin film cover, the vent line being thinner than a remaining region of the first thin film cover.

According to one or more embodiments, the vent line may have a cross, a circle, or a rectangular shape.

According to one or more embodiments, the vent line may have a thickness that is suitable for rupturing of the vent line in a case where an internal pressure of the can-type case is equal to or greater than a threshold value.

According to one or more embodiments, the thickness of a surrounding region of the vent line may decrease in a direction from outside to inside.

According to one or more embodiments, an adhesive force between the first thin film cover and the second thin film cover may be greater than an adhesive force between the can-type case and the second thin film cover.

According to one or more embodiments, each of the first thin film cover and the second thin film cover may include a substrate layer which is a metal layer or a polymer layer.

According to one or more embodiments, each of the first thin film cover and the second thin film cover may include an adhesive layer under the substrate layer.

According to one or more embodiments of the present disclosure, a manufacturing method of a secondary battery includes injecting an electrolyte into an electrolyte inlet on a first end of a can-type case for accommodating an electrode assembly, sealing an outer portion of the electrolyte inlet with a first thin film cover, forming a through-hole in the first thin film cover exposing the electrolyte inlet, injecting the electrolyte into the electrolyte inlet exposed through the through-hole, and sealing the electrolyte inlet and the through-hole with a second thin film cover on the first thin film cover.

According to one or more embodiments, the through-hole of the first thin film cover may be formed by punching the first thin film cover.

According to one or more embodiments, the through-hole may be formed by rupturing a vent line at an outer portion of the electrolyte inlet of the first thin film cover, the vent line being thinner than a remaining region of the first thin film cover.

According to one or more embodiments of the present disclosure, a manufacturing method of a secondary battery includes injecting an electrolyte into an electrolyte inlet at a first end of a can-type case for accommodating an electrode assembly, sealing an outer portion of the electrolyte inlet with a first thin film cover, removing the first thin film cover, injecting the electrolyte into the electrolyte inlet exposed by the removal of the first thin film cover, and sealing the electrolyte inlet with a second thin film cover.

According to one or more embodiments, in the removing of the first thin film cover, the first thin film cover may be removed by pulling a handle member on a distal end of the first thin film cover.

According to one or more embodiments, in the removing of the first thin film cover, a bend portion may be formed by bending a region of the first thin film cover, and the first thin film cover may be removed by pulling the bend portion.

According to one or more embodiments, after the first thin film cover is removed, the second thin film cover may be attached at a position other than an attachment position between the first thin film cover and the can-type case.

According to one or more embodiments, the first thin film cover and the second thin film cover may be attached to the can-type case by welding.

According to one or more embodiments, the first thin film cover and the second thin film cover may be attached to the can-type case by thermocompression bonding.

According to one or more embodiments, the attachment position of at least one of the first thin film cover or the second thin film cover to the can-type case may be a peripheral portion of the at least one of the first thin film cover or the second thin film cover.

According to one or more embodiments of the present disclosure, the degree of electrolyte impregnation may be improved by further electrolyte injection to solve the problems such as electrolyte depletion or changes in electrolyte distribution due to repeated charging and discharging that would otherwise degrade the life characteristics of a secondary cell.

One or more embodiments of the present disclosure may solve the problems such as a stopper on a member extending through the entirety or a portion of the electrolyte inlet not being readily removable from the electrolyte inlet or reduced seal reliability due to a micro-gap at the boundary with the electrolyte inlet.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings:

FIG. 1 illustrates a perspective view showing a secondary battery according to one or more embodiments of the present disclosure.

FIG. 2 illustrates a cross-sectional view showing a secondary battery according to a comparative example of the present disclosure.

FIG. 3 illustrates a flowchart showing a manufacturing method of a secondary battery according to one or more embodiments of the present disclosure.

FIG. 4 illustrates a manufacturing process of a secondary battery according to one or more embodiments of the present disclosure.

FIG. 5 illustrates a process of manufacturing a secondary battery according to one or more embodiments of the present disclosure.

FIG. 6 illustrates a process of manufacturing a first thin film cover according to one or more embodiments of the present disclosure.

FIG. 7 illustrates a cross-sectional view showing a first thin film cover according to one or more embodiments of the present disclosure.

FIG. 8 illustrates a flowchart showing a manufacturing method of a secondary battery according to one or more embodiments of the present disclosure.

FIG. 9 illustrates a process of manufacturing a secondary battery according to one or more embodiments of the present disclosure.

FIG. 10 illustrates a process of manufacturing a secondary battery according to one or more embodiments of the present disclosure.

FIG. 11 illustrates a process of removing a first thin film cover according to one or more embodiments of the present disclosure.

FIG. 12 illustrates a process of removing a first thin film cover according to one or more embodiments of the present disclosure.

FIG. 13 illustrates a process of attaching a first thin film cover and a second thin film cover according to one or more embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

Terms used herein are intended to describe embodiments of the present disclosure and are not intended to limit the present disclosure.

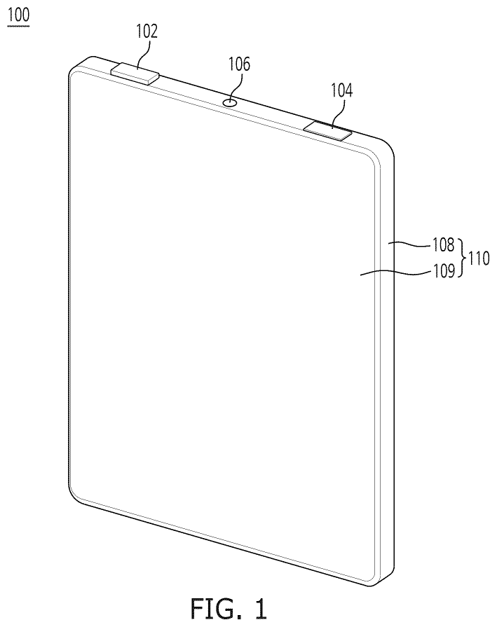

FIG. 1 illustrates a perspective view showing a secondary battery according to one or more embodiments of the present disclosure. FIG. 1 shows a can-type secondary battery.

Throughout the present disclosure, can-type secondary batteries having a metal shell are mainly described, but the present disclosure is not limited thereto and may be applied to any type of secondary battery having a metal can. The material of the can may be any material having good electrical and thermal conductivity, such as stainless steel (SUS).

Referring to FIG. 1, the case 110 of the secondary battery 100 according to one or more embodiments may include: a lower can 108 having an internal space for accommodating an electrode assembly and an electrolyte, with a flange provided on at least one side (e.g., four sides) of an open area; and a plate-shaped upper cover 109 seated on the flange of the lower can and joined to the lower can by laser welding along the at least one side. In this case, the flange remaining outside the laser-welded portion may be removed by a cutting process to produce the can-shaped case 110 as shown in FIG. 1.

The lower can 108 of the case 110 may be a container having a generally rectangular parallelepiped shape and formed from a metal, as shown in FIG. 1, and may be produced by a processing method such as deep drawing. Accordingly, the can itself may serve as a terminal.

According to one or more embodiments, the secondary battery may have a structure in which a cap plate is welded to the can, in which the first terminal, the second terminal, the electrolyte inlet, and the like are provided on the cap plate. For example, the secondary battery 100 may have a structure in which the lower can 108 is integrally provided with a first terminal 102, a second terminal 104, an electrolyte inlet 106, and/or the like, and the upper cover 109 is welded to the can.

In the secondary battery 100 according to one or more embodiments, after initial injection of the electrolyte, pre-charging and aging processes may be performed for electrolyte impregnation. For this purpose, a separate electrolyte inlet 106 may be provided outside the case 110.

According to one or more embodiments, the first terminal 102, the second terminal 104, the electrolyte inlet 106, a protection circuit module (PCM), and/or the like may be provided on one side of the case 110. In a case where the first terminal 102 is a positive terminal, the second terminal 104 may be a negative terminal. In another example, in a case where the first terminal 102 is a negative terminal, the second terminal 104 may be a positive terminal. Each of the first terminal 102 and the second terminal 104 may have various shapes, such as a plate shape and a rivet shape, and the shape and size thereof are not limited.

In one or more embodiments, the PCM is a protective circuit device having over-discharge, overcharge, and overcurrent protection functions for the secondary battery 100, and is not shown in FIG. 1.

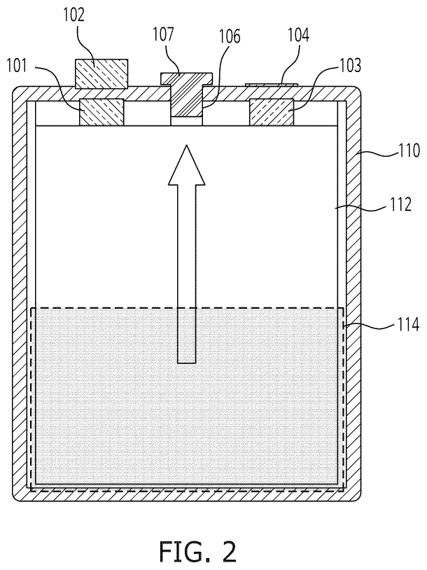

FIG. 2 illustrates a cross-sectional view showing a secondary battery according to a comparative example of the present disclosure. The arrow indicates a direction in which an electrolyte 114 is injected and the level thereof rises.

Referring to FIG. 2, a first electrode tab 101 integrally provided on or welded to an uncoated portion of a first electrode without an active material applied thereto may be electrically connected to the first terminal 102, and a second electrode tab 103 integrally provided on or welded to an uncoated portion of a second electrode without an active material applied thereto may be electrically connected to the second terminal 104. In another example, a first lead tab connected to the first electrode tab 101 may be electrically connected to the first terminal 102, and a second lead tab connected to the second electrode tab 103 may be electrically connected to the second terminal 104. Herein, the first electrode tab 101 (or the second electrode tab 103) may refer to an electrode tab group in which a plurality of electrode tabs of each wound or stacked electrode plate are stacked.

The case 110 may accommodate therein an electrode assembly 112 provided by stacking or winding unit cells, each of which includes a positive electrode plate, a negative electrode plate, and a separator provided between the positive electrode plate and the negative electrode plate to insulate between the positive electrode plate and the negative electrode plate. The electrode assembly 112 may undergo the aging process in which the electrode assembly 112 is impregnated with the electrolyte 114 injected through the electrolyte inlet 106. The electrolyte 114 is a liquid electrolyte that may provide a path for ions to travel between the positive electrode and the negative electrode to facilitate battery reactions. In addition, the electrolyte 114 may stabilize the surfaces of the positive and negative electrodes and improve the lifetime and battery characteristics of a secondary battery. For example, in the case of a secondary battery, the electrolyte 114 may include an electrolyte salt, an organic solvent, and additives.

The electrolyte inlet 106 is a through-hole allowing the electrolyte 114 to be injected into the case 110 therethrough. Referring to FIG. 2, the electrolyte inlet 106 according to a comparative example of the present disclosure may be sealed by placing a ball, a rivet, or a pin having a larger diameter than the electrolyte inlet 106 at the mouth of the electrolyte inlet 106 and mechanically pressing the ball, rivet, or pin into the electrolyte inlet 106 to form a stopper 107.

In another example, the electrolyte inlet 106 may be sealed by welding the stopper 107 to a first end of the case 110 once to reliably block leakage of the electrolyte 114. Because the case 110 is typically formed from a material having high electrical and thermal conductivity, laser welding may be mainly used. For example, in a case where a laser beam is irradiated to a weld, which is a peripheral portion of the stopper 107, welding may be performed by partially melting the stopper and the inner surface of the electrolyte inlet of the case at the weld.

The shape and size of the stopper 107 is not limited, and the stopper 107 according to a comparative example of the present disclosure may be a member that extends through the entirety or a portion of the electrolyte inlet 106.

However, according to a comparative example of the present disclosure, after the electrolyte 114 is injected through the electrolyte inlet 106, before the stopper 107 is mechanically press-fitted into and/or welded to the electrolyte inlet 106, the electrolyte 114 may already be stained on the inner surface of the electrolyte inlet 106. In another example, the electrolyte 114 may have risen to the mouth of the electrolyte inlet 106 due to the over-injected electrolyte 114. In another example, even in a case where the electrolyte 114 is not caused to leak to the top surface of the case 110 by the stopper 107 after the formation of the stopper 107, the electrolyte 114 may fill a small gap that may be present between the stopper 107 and the electrolyte inlet 106.

According to a comparative example of the present disclosure, there may be a problem that to address this issue, it is desirable to use a separate process, such as applying rubber packing to the closure for a reliable welded finish and sealing of the electrolyte inlet 106, after the injection of the electrolyte 114. In addition, in some cases, it may be desirable (or necessary) to repeat further injection of the electrolyte. According to a comparative example of the present disclosure, there may be a problem that it may be difficult to remove the stopper 107 including a member extending through the electrolyte inlet 106 because the stopper 107 is mechanically press-fitted and/or welded.

Further electrolyte injection is desirable in a secondary battery because, as the battery is repeatedly charged and discharged, problems, such as electrolyte depletion or changes in electrolyte distribution, may occur, thereby degrading the life characteristics of the battery. Therefore, it may be desirable to increase the degree of electrolyte impregnation by adding further electrolyte.

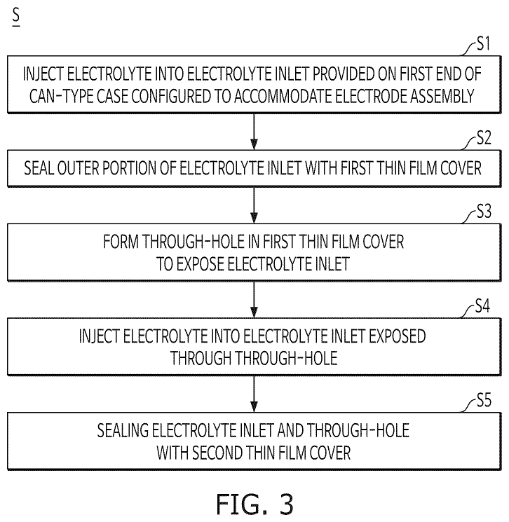

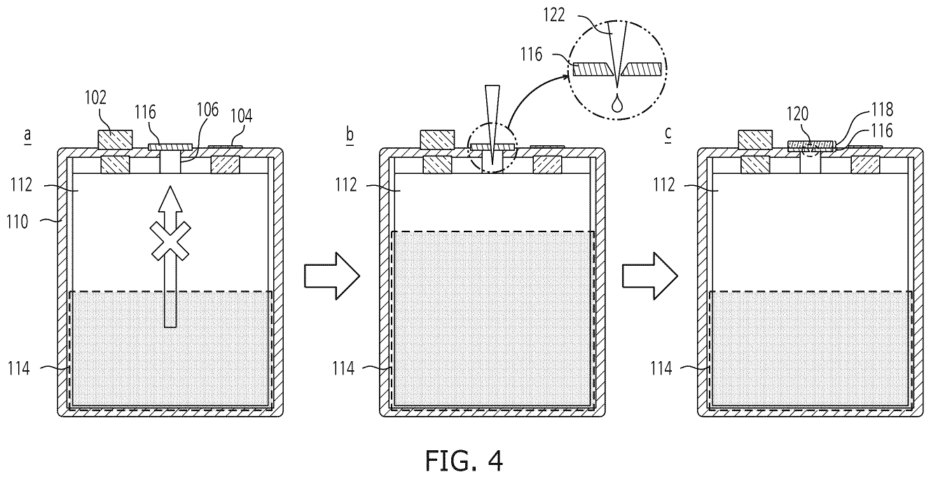

FIG. 3 illustrates a flowchart showing a manufacturing method of a secondary battery according to one or more embodiments of the present disclosure. FIG. 4 illustrates a manufacturing process of a secondary battery according to one or more embodiments of the present disclosure.

A manufacturing method S of a secondary battery according to one or more embodiments of the present disclosure may include: an operation S1 of injecting an electrolyte into an electrolyte inlet provided on a first end of a can-type case configured to accommodate an electrode assembly; an operation S2 of sealing an outer portion of the electrolyte inlet with a first thin film cover; an operation S3 of forming a through-hole in the first thin film cover to expose the electrolyte inlet; an operation S4 of injecting the electrolyte into the electrolyte inlet exposed through the through-hole; and an operation S5 of sealing the electrolyte inlet and the through-hole with a second thin film cover.

Referring to FIG. 4, the secondary battery manufactured accordingly may include a can-type case 110 configured to accommodate an electrode assembly 112; an electrolyte inlet 106 provided on a first end of the case 110 and into which an electrolyte 114 is injected; a first thin film cover 116 configured to seal the electrolyte inlet 106 and having a through-hole 120 formed by a subsequent through-hole forming operation; and a second thin film cover 118 configured to seal the electrolyte inlet 106 and the through-hole 120. In this case, the second thin film cover 118 may be disposed over the first thin film cover 116.

According to one or more embodiments, after the initial injection of the electrolyte, pre-charging and aging processes may be performed. For example, a can-type secondary battery may have a high possibility for electrolyte leakage during the electrolyte aging process due to the properties thereof. In addition, there is a possibility of internal contamination of the secondary battery during the aging process. Therefore, referring to FIG. 4, the outer portion of the electrolyte inlet 106 may be sealed with a first thin film cover 116 to prevent the leakage of the electrolyte 114 and the internal contamination of the secondary battery (e.g., see operation “a” of FIG. 4). The material of the thin film cover and an attachment method for sealing will be described later.

According to one or more embodiments, the through-hole 120 may be formed in the first thin film cover 116 to expose the electrolyte inlet 106 for second injection of the electrolyte. For example, an electrolyte supply portion of an electrolyte injector 122 for the second injection of the electrolyte may have a pointed shape as shown in FIG. 4. With the pointed shape of the electrolyte supply portion, the first thin film cover 116 may be punched to form the through-hole 120 (e.g., see operation “b” of FIG. 4). The electrolyte injector 122 may be configured to inject the electrolyte 114 after the punching. In this case, the second injection of the electrolyte may be performed without a separate process for forming the through-hole 120 in the first thin film cover 116.

The electrolyte 114 may be further injected into the exposed electrolyte inlet 106 through the through-hole 120 of the first thin film cover 116 (e.g., see operation “b” of FIG. 4). Once the electrolyte injection is complete, the electrolyte inlet 106 and the through-hole 120 may be sealed with the second thin film cover 118 (e.g., see operation “c” of FIG. 4). Accordingly, after the further injection of the electrolyte 114 is complete, final sealing may be performed. After the sealing, a second aging process may be performed. Throughout this specification, the electrolyte injections are referred to as the first and second injections, but the number of the further electrolyte injections is not limited thereto.

The arrow in operation a may indicate the function of the first thin film cover 116 preventing the electrolyte 114 from leaking. Referring to FIG. 4, the level to which the electrolyte 114 rises may indicate a process of rising or impregnation of the electrolyte 114. For example, the operation “a” of FIG. 4 may represent a process in which the level of the electrolyte 114, which has risen rapidly to a level (e.g., a predetermined level) immediately after the initial injection of the electrolyte 114, lowers as the electrode assembly 112 is gradually impregnated with the electrolyte 114 during the pre-charging and aging. The operation “b” of FIG. 4 may represent a situation in which the absolute amount of the electrolyte 114 within the case 110 has increased by the second injection of the electrolyte 114 by the electrolyte injector 122. The operation “c” may represent a situation in which the height of the electrolyte 114 has lowered due to the electrolyte impregnation into the electrode assembly 112 during the second aging process.

According to one or more embodiments of the present disclosure, as shown in FIG. 4, the first thin film cover 116 may have a smaller thickness than the second thin film cover 118. The thickness of the first thin film cover 116 may refer to the thickness of an area other than the through-hole 120 formed in the first thin film cover 116. Specifically, the first thin film cover 116 may be relatively thinner in thickness than the second thin film cover 118 to facilitate the formation of the through-hole 120 by the punching process.

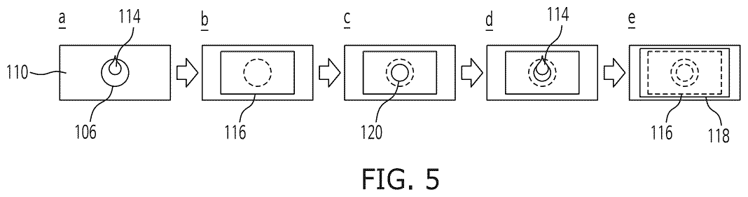

FIG. 5 illustrates a process of manufacturing a secondary battery according to one or more embodiments of the present disclosure. FIG. 5 illustrates the electrolyte inlet of the secondary battery viewed from above. Description of the same as described above may be omitted.

According to one or more embodiments, the first thin film cover 116 is larger than the electrolyte inlet 106 provided on the first end of the case 110, so that the first thin film cover 116 may cover the outer portion of the electrolyte inlet 106. Accordingly, the electrolyte inlet 106 may be properly sealed to prevent the leakage, internal contamination, and/or the like of the electrolyte 114. The outer portion of the electrolyte inlet 106 may refer to a portion of the inlet that is exposed to the outside.

Referring to FIG. 5, the first thin film cover 116 and the second thin film cover 118 are shown in a rectangular shape, but throughout the present disclosure, the shape of the thin film cover is not limited.

According to one or more embodiments, the second thin film cover 118 may have a larger size than the first thin film cover 116. Because the second thin film cover 118 may be disposed over the first thin film cover 116, attachment thereof to the case 110 may be facilitated in a case where the size of the second thin film cover 118 is greater than the area occupied by the first thin film cover 116. For example, because the through-hole 120 is formed in the first thin film cover 116, the attachment between the second thin film cover 118 and the first thin film cover 116 may be weaker than the attachment between the second thin film cover 118 and the case 110. In another example, the first thin film cover 116 and the second thin film cover 118 may be attached in such a manner that peripheral portions of the first thin film cover 116 and the second thin film cover 118 are welded or pressed to an object, as described later. In a case where the attachment portion of the second thin film cover 118 overlaps the attachment portion of the first thin film cover 116, the attachment may be weak. Accordingly, there may be a size difference between the thin film covers to overcome the problem described above.

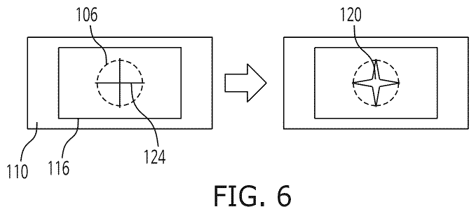

FIG. 6 illustrates a process of manufacturing a first thin film cover according to one or more embodiments of the present disclosure. FIG. 6 illustrates the shape of the secondary battery in a direction in which the electrolyte inlet is viewed.

As shown on the left side of FIG. 6, vent lines 124 may be provided in the first thin film cover 116 disposed on the outer portion of the electrolyte inlet 106, and as shown on the right side, the vent lines 124 may be ruptured to form a through-hole 120. Referring to FIG. 6, the shape of the vent lines is shown as a cross “+”, but may be circular, rectangular, and/or the like, and is not limited to any shape.

The vent lines 124 may be configured to have a smaller thickness than other areas of the first thin film cover 116. Accordingly, the through-hole 120 may be more easily formed.

According to one or more embodiments, the vent lines 124 may be ruptured to form the through-hole 120. For example, the vent lines 124 may be ruptured by punching the electrolyte injector 122 to form the through-hole 120. In this case, the through-hole 120 may be easily formed with less force than in a case without the vent lines 124.

In another example, as the internal temperature of the case 110 may increase as the charging and discharging processes progress, the electrolyte may evaporate, thereby causing the internal pressure to increase. In a case where the internal pressure is equal to or greater than a threshold value, the vent lines 124 may be ruptured to form the through-hole 120. Herein, the threshold value may be equal to the internal pressure corresponding to the ignition temperature of the secondary battery. Accordingly, the threshold value may vary depending on the type, size, battery capacity, and/or the like of the secondary battery, but is not limited thereto.

In a case where the ignition temperature is reached, the secondary battery may be ignited and undergo a thermal runaway phenomenon. In a case where the vent lines 124 of the secondary battery are ruptured before the ignition temperature is reached, gas may be discharged through the through-hole 120 formed by the ruptured vent lines 124 to reduce the internal pressure, and the electrolyte may be released. As a result, the thermal runaway phenomenon may be prevented. In this case, the process of manufacturing a separate notched vent in the can-type secondary battery may be omitted.

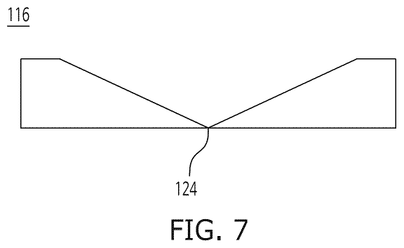

FIG. 7 illustrates a cross-sectional view showing a first thin film cover according to one or more embodiments of the present disclosure. Description overlapping with the description of FIG. 6 may be omitted.

The vent lines 124 may be configured to have a thinner thickness than other portions of the first thin film cover 116. Specifically, the thickness of the portions around the vent lines 124 may be configured to decrease in a direction from the outside to the inside, as shown in FIG. 7.

More specifically, the vent lines 124 may be configured to have a thickness capable of rupturing in a case where the internal pressure of the can-type case 110 is equal to or greater than a threshold value. As described above, the threshold value may refer to the internal pressure corresponding to the ignition temperature of the secondary battery, and the vent lines 124 may be formed on the first thin film cover 116 by calculating the thickness that may rupture based on the threshold value.

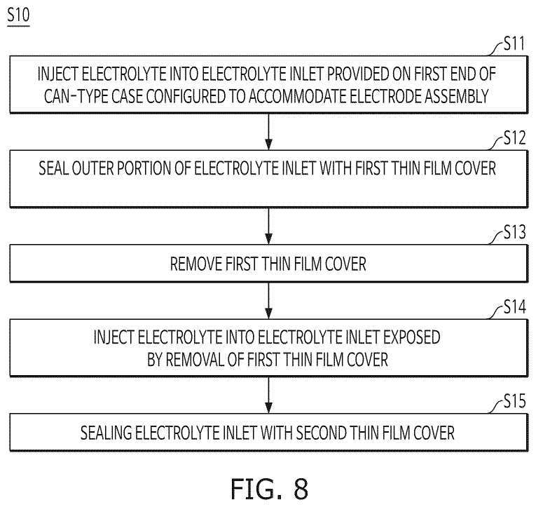

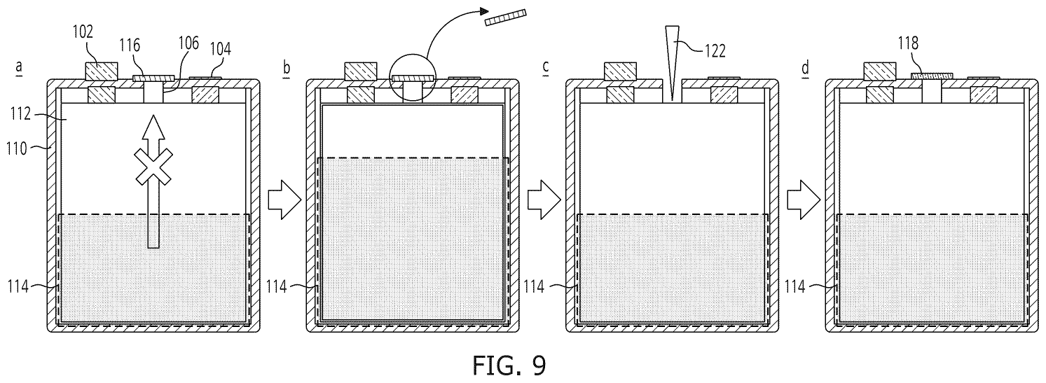

FIG. 8 illustrates a flowchart showing a manufacturing method of a secondary battery according to one or more embodiments of the present disclosure. FIG. 9 illustrates a process of manufacturing a secondary battery according to one or more embodiments of the present disclosure. Description overlapping with the description of FIGS. 3 and 4 may be omitted.

A manufacturing method S10 of a secondary battery according to one or more embodiments of the present disclosure may include: an operation S11 of injecting an electrolyte into an electrolyte inlet provided on a first end of a can-type case configured to accommodate an electrode assembly; an operation S12 of sealing an outer portion of the electrolyte inlet with a first thin film cover; an operation S13 of removing the first thin film cover; an operation S14 of injecting the electrolyte into the electrolyte inlet exposed by the removal of the first thin film cover; and an operation S15 of sealing the electrolyte inlet with a second thin film cover.

Referring to FIG. 9, the secondary battery manufactured as above may include a can-type case 110 configured to accommodate an electrode assembly 112, an electrolyte inlet 106 provided on a first end of the case 110 and allowing an electrolyte 114 to be injected therethrough, and a second thin film cover 118 configured to seal the electrolyte inlet 106 (e.g., see operation “d” of FIG. 9)

According to one or more embodiments, in the can-type secondary battery, after the initial injection of the electrolyte 114, pre-charging and aging processes may be performed. The outer portion of the electrolyte inlet 106 may be sealed with a first thin film cover 116 to prevent the leakage of the electrolyte 114 and the internal contamination of the secondary battery cell (e.g., see operation “a” of FIG. 9). The material of the thin film cover and the attachment method for sealing will be described later.

Thereafter, the first thin film cover 116 may be removed (e.g., see operation “b” of FIG. 9). A method of removing the first thin film cover 116 will be described later.

Thereafter, the electrolyte 114 may be further injected into the electrolyte inlet 106 exposed by the removal of the first thin film cover 116 (e.g., see operation “c” of FIG. 9), and the electrolyte inlet 106 may be sealed with the second thin film cover 118 (e.g., see operation “d” of FIG. 9). Accordingly, the further aging process may be performed, and at the same time, the internal contamination of the battery and the leakage of the electrolyte 114 may be prevented.

The decreased level of the electrolyte in operation c may be due to the electrode assembly 112 being impregnated with the electrolyte 114 during the second aging process.

The number of the further electrolyte injections is not limited. Thus, for example, the second thin film cover 118 may be removed, and final sealing may be performed with a third thin film cover. Because the thin film cover may be repeatedly attached and removed as described above, there is an advantage that additional electrolyte may be easily replenished.

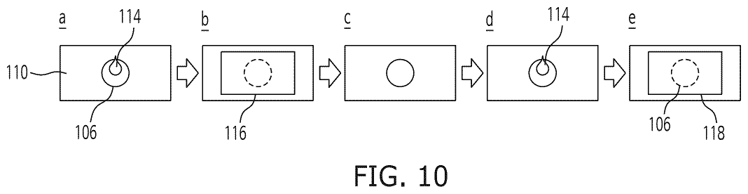

FIG. 10 illustrates a process of manufacturing a secondary battery according to one or more embodiments of the present disclosure. FIG. 10 illustrates the electrolyte inlet of the secondary battery viewed from above. Overlapping description may be omitted.

According to one or more embodiments, the first thin film cover 116 may be larger than the electrolyte inlet 106 provided on a first end of the case 110 so as to cover the outer portion of the electrolyte inlet 106. Accordingly, the electrolyte inlet 106 may be properly sealed to prevent the leakage of the electrolyte 114, internal contamination, and/or the like.

According to one or more embodiments, the second thin film cover 118 may be smaller or larger in size than the first thin film cover 116. Herein, the second thin film cover 118 may be larger than the electrolyte inlet 106 provided on the first end of the case 110 so as to cover the outer portion of the electrolyte inlet 106. Accordingly, the electrolyte inlet 106 may be properly sealed to prevent the leakage of the electrolyte 114 that is secondarily injected, internal contamination, and/or the like.

Referring to FIG. 10, the first thin film cover 116 before being removed and the second thin film cover configured to seal the electrolyte inlet are shown to be of the same size, but are not limited thereto.

As will be described later, an adhesive layer may be disposed under the entire surface of the thin film cover such that the attachment position of the thin film cover to the case 110 is the entire surface. In this case, due to the properties of the material that may be easily removed by the adhesive layer, a foreign object sensation may not occur in the area where the first thin film cover 116 was attached. Therefore, the second thin film cover 118 may be attached at the position where the first thin film cover 116 was attached. Accordingly, the size of the second thin film cover 118 is not limited and may be the same as or different from the size of the first thin film cover 116.

According to one or more embodiments of the present disclosure, after the first thin film cover 116 is removed, the second thin film cover 118 may be attached at a position other than the attachment position between the first thin film cover 116 and the can-type case 110. For example, in a case where the thin film cover is attached to the case by welding, the attachment position or the welding position may be a peripheral portion of the thin film cover. In this case, the surface of the case 110 from which the first thin film cover 116 is removed may have a trace of the weld at the welding position. Accordingly, the second thin film cover 118 may be attached to the case at a position other than the position of the weld between the first thin film cover 116 and the case 110. In other words, the second thin film cover 118 may be smaller or larger than the first thin film cover 116.

In another example, in a case where the thin film cover is hot-pressed to the case, the attachment position or the hot-pressed position may be a peripheral portion of the thin film cover. In this case, the side of the case 110 from which the first thin film cover 116 is removed may have a trace of the thermocompression bonding at the thermocompression bonded position. Accordingly, the second thin film cover 118 may be attached to the case at a position other than the hot-pressed position between the first thin film cover 116 and the case 110. In other words, the second thin film cover 118 may be smaller or larger than the first thin film cover 116.

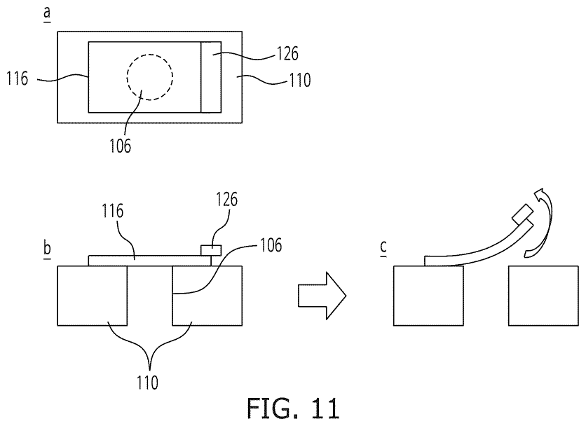

FIG. 11 illustrates a process of removing a first thin film cover according to one or more embodiments of the present disclosure.

Referring to FIG. 11, in an operation of removing the first thin film cover, the first thin film cover 116 may be removed by pulling a handle member 126 disposed on the distal end of the first thin film cover 116. The handle member 126 is disposed on the first thin film cover 116, and regardless of the material of the first thin film cover 116, is not limited as to any shape, size, orientation on the thin film cover, and material, so long as the handle member may facilitate the process of removal from the case 110. In addition, for example, in a case where the electrolyte is injected three or more times, the second thin film cover 118 is removed, and the third thin film cover is attached, the handle member 126 may be disposed on the distal end of the second thin film cover 118.

The handle member 126 may facilitate the removal of the thin film cover, thereby reducing the time of the electrolyte injection process.

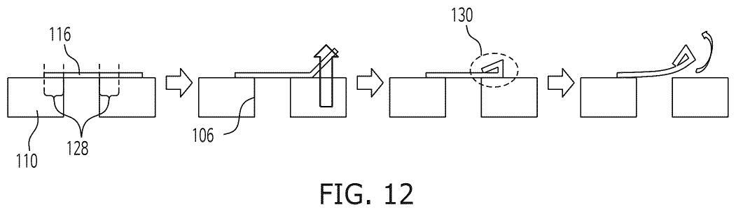

FIG. 12 illustrates a process of removing a first thin film cover according to one or more embodiments of the present disclosure.

According to one or more embodiments, in an operation of removing the first thin film cover 116, a portion of the first thin film cover 116 may be folded to form a bend portion 130, as shown in FIG. 12, and the first thin film cover 116 may be easily removed by pulling the bend portion 130. For example, the bend portion 130 may be formed by bending a region of the first thin film cover 116 that is a region outside the attachment position 128 between the first thin film cover 116 and the case 110 while being a distal region of the first thin film cover 116. The position, orientation, shape, and/or the like of the region where the bend 130 is formed is not limited, so long as the first thin film cover 116 may be easily removed by the bend 130. In addition, for example, in a case where the electrolyte is dispensed three or more times, the second thin film cover 118 is removed, and the third thin film cover is attached, the bend portion 130 may be disposed in a region of the second thin film cover 118.

By using the bending portion 130, the process of adding a separate handle member may be omitted. The bending portion 130 may also facilitate the removal of the thin film cover, thereby reducing the time of the electrolyte injection process.

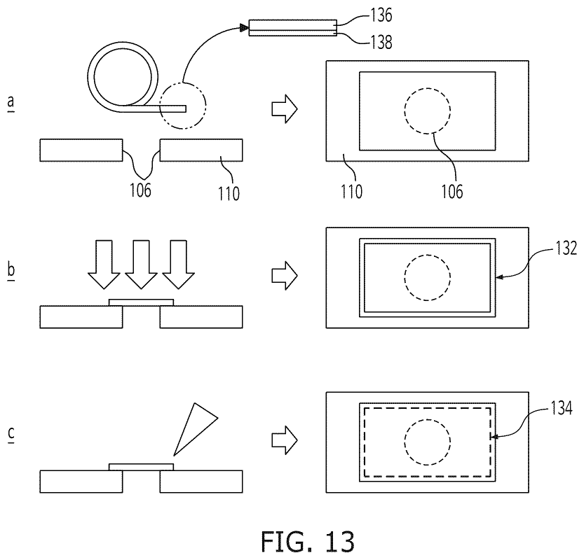

FIG. 13 illustrates a process of attaching a first thin film cover and a second thin film cover according to one or more embodiments of the present disclosure. FIG. 13 illustrates attachment methods including a tape attachment method “a”, a pressing attachment method “b”, and a welding attachment method “c”. The techniques that are redundant to the above are omitted.

According to one or more embodiments of the present disclosure, the thin film cover may include a substrate layer 136, which may be one of a metal layer and a polymer layer. In a case where the substrate layer 136 is a metal layer, the substrate layer 136 may be attached to the can-type case 110 by welding. In a case where the base layer 136 is a polymer layer, the base layer 136 may be attached to the case 110 by thermocompression bonding.

In addition, as shown in FIG. 13, in the method “a” of FIG. 13, the thin film cover may further include an adhesive layer 138 under the substrate layer 136. The thickness of the adhesive layer 138 may be thin relative to the thickness of the substrate layer 136 as a means of providing adhesion to the substrate layer 136. In a case where the thin film cover includes the adhesive layer 138, the attachment position to the case 110 may be the entire surface of the thin film cover. In the present disclosure, the attachment position may refer to an area where the two objects are substantially joined, rather than merely overlapping.

The material of the thin film cover may be, but not limited to, a metal, a polymer, and/or a material in which an adhesive material is applied to a metal and/or a polymer. Furthermore, the first thin film cover and the second thin film cover may be of different composition materials.

According to one or more embodiments of the present disclosure, as shown in FIG. 13, the attachment position of the first thin film cover 116 and/or the second thin film cover 118 to the case 110 may be a peripheral portion of the thin film cover. For example, in a case where the thin film cover is attached to the case 110 by welding in the method “c” of FIG. 13, an attachment position or welding position 134 may be a peripheral portion of the thin film cover. Herein, the peripheral portion may be a portion that allows the through-hole to be sealed as a result of the welding attachment. In another example, in a case where the thin film cover is hot-pressed to the case 110 in the method “b” of FIG. 13, the attachment position or pressing position 132 may be a peripheral portion of the thin film cover. Herein, the peripheral portion may be a portion that allows the through-hole to be sealed as a result of the hot-pressing attachment. Referring to FIG. 13, for ease of understanding, the pressing position 132 is shown as a closed region and the welding position 134 is shown as a dotted line. The welding position 134 in the method “c” of FIG. 13 where the thin film cover is attached by welding may occupy a smaller area compared to the pressurized position 132 in the method “b” of FIG. 13 where the thin film cover is attached using temperature and pressure, for example, by thermocompression bonding. For example, the pressurized position 132 may include the welding position 134.

According to one or more embodiments, the material of the thin film cover may be selected such that the adhesive force between the first thin film cover and the second thin film cover is greater than the adhesive force between the can type case 110 and the second thin film cover. In a case where the second thin film cover is attached to the first thin film cover having the through-hole, it is desirable that the second thin film cover may be attached more strongly just by selecting the material of the thin film cover.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

### DESCRIPTION OF REFERENCE SYMBOLS

100: secondary battery
101: first electrode tab
102: first terminal
103: second electrode tab
104: second terminal
106: electrolyte inlet
107: stopper
108: lower can
109: upper cover
110: case
112: electrode assembly
114: electrolyte
116: first thin film cover
118: second thin film cover
120: through-hole
122: electrolyte injector
124: vent line
126: handle member
128: attachment position
130: bend portion
132: pressing position
134: welding position
136: substrate layer
138: adhesive layer

What is claimed is:

1. A secondary battery comprising:
a can-type case accommodating an electrode assembly;
an electrolyte inlet on a first end of the case, and configured to allow an electrolyte to be injected therethrough;
a first thin film cover sealing the electrolyte inlet, and having a through-hole; and
a second thin film cover sealing the electrolyte inlet and the through-hole, and located on the first thin film cover.

2. The secondary battery as claimed in claim 1, wherein the first thin film cover is thinner than the second thin film cover.

3. The secondary battery as claimed in claim 1, wherein the first thin film cover is larger than the electrolyte inlet and covers an outer portion of the electrolyte inlet, and
wherein the second thin film cover is larger than the first thin film cover.

4. The secondary battery as claimed in claim 1, wherein the through-hole is formed by rupturing a vent line on an outer portion of the electrolyte inlet of the first thin film cover,
the vent line being thinner than a remaining region of the first thin film cover.

5. The secondary battery as claimed in claim 4, wherein the vent line has a cross, a circle, or a rectangular shape.

6. The secondary battery as claimed in claim 4, wherein the vent line has a thickness that is suitable for rupturing of the vent line in a case where an internal pressure of the can-type case is equal to or greater than a threshold value.

7. The secondary battery as claimed in claim 4, wherein the thickness of a surrounding region of the vent line decreases in a direction from outside to inside.

8. The secondary battery as claimed in claim 1, wherein an adhesive force between the first thin film cover and the second thin film cover is greater than an adhesive force between the can-type case and the second thin film cover.

9. The secondary battery as claimed in claim 1, wherein each of the first thin film cover and the second thin film cover comprises a substrate layer comprising a metal layer or a polymer layer.

10. The secondary battery as claimed in claim 9, wherein each of the first thin film cover and the second thin film cover comprises an adhesive layer under the substrate layer.

11. A manufacturing method of a secondary battery, the manufacturing method comprising:
injecting an electrolyte into an electrolyte inlet on a first end of a can-type case for accommodating an electrode assembly;
sealing an outer portion of the electrolyte inlet with a first thin film cover;
forming a through-hole in the first thin film cover exposing the electrolyte inlet;
injecting the electrolyte into the electrolyte inlet exposed through the through-hole; and
sealing the electrolyte inlet and the through-hole with a second thin film cover on the first thin film cover.

12. The manufacturing method as claimed in claim 11, wherein the through-hole of the first thin film cover is formed by punching the first thin film cover.

13. The manufacturing method as claimed in claim 11, wherein the through-hole is formed by rupturing a vent line at an outer portion of the electrolyte inlet of the first thin film cover,
the vent line being thinner than a remaining region of the first thin film cover.

14. A manufacturing method of a secondary battery, the manufacturing method comprising:
injecting an electrolyte into an electrolyte inlet at a first end of a can-type case for accommodating an electrode assembly;
sealing an outer portion of the electrolyte inlet with a first thin film cover;
removing the first thin film cover;
injecting the electrolyte into the electrolyte inlet exposed by the removal of the first thin film cover; and
sealing the electrolyte inlet with a second thin film cover.

15. The manufacturing method as claimed in claim 14, wherein in the removing of the first thin film cover,
the first thin film cover is removed by pulling a handle member on a distal end of the first thin film cover.

16. The manufacturing method as claimed in claim 14, wherein in the removing of the first thin film cover,
a bend portion is formed by bending a region of the first thin film cover, and the first thin film cover is removed by pulling the bend portion.

17. The manufacturing method as claimed in claim 14, wherein after the first thin film cover is removed, the second thin film cover is attached at a position other than an attachment position between the first thin film cover and the can-type case.

18. The manufacturing method as claimed in claim 11, wherein the first thin film cover and the second thin film cover are attached to the can-type case by welding.

19. The manufacturing method as claimed in claim 11, wherein the first thin film cover and the second thin film cover are attached to the can-type case by thermocompression bonding.

20. The manufacturing method as claimed in claim 11, wherein the attachment position of at least one of the first thin film cover or the second thin film cover to the can-type case is a peripheral portion of the at least one of the first thin film cover or the second thin film cover.
